(19) United States
(12) Patent Application Publication
(10) Pub. No.: US 2005/0273324 A1
(43) Pub. Date: Dec. 8, 2005

(54) System for providing audio data and providing method thereof

(75) Inventor: Kyueun Yi, Irvine, CA (US)

Correspondence Address: FULBRIGHT AND JAWORSKI LLP, 555 S. FLOWER STREET, 41ST FLOOR, LOS ANGELES, CA, 90071, US

(73) Assignee: EXPAMEDIA, INC.

(21) Appl. No.: 11/147,593

(22) Filed: Jun. 6, 2005

Related U.S. Application Data
(60) Provisional application No. 60/578,717, filed on Jun. 8, 2004.

(51) Int. Cl. G10L 21/02

(52) U.S. Cl. 704/226

(57) ABSTRACT

Disclosed is a system and method for providing audio data. The present system is connected to a user terminal over a network for providing audio data to the user terminal, and includes a condition setting unit and an audio data processor. When audio data provision conditions including conditions regarding virtual location of sound sources are set in the condition setting unit by the user, the audio data processor convolutes an input audio signal with a preset transfer function based on the set conditions regarding virtual location of sound sources, thereby giving the input audio signal a 3D sound effect in directions desired by the user. Therefore, the user can enjoy sound with the 3D sound effect in the desired directions over the network.

### BACKGROUND OF THE INVENTION

(a) Field of the Invention

The present invention relates to a system and method for providing audio data, and more particularly, to a system connected to a user terminal over a network for providing the user terminal with the audio data.

(b) Description of the Related Art

A 5.1 channel is used to bring up a 3D sound effect for audio data provided to users. The 5.1 channel refers to left, right, center, surround left, surround right, and low frequency effect channels.

Generally, the center channel, the right and left channels, and the right and left surround channels have directional components at the center, right and left 30 degrees, and right and left 120 degrees locations with respect to a listener, respectively, and the low frequency effect channel does not have any directional component since it has a bandwidth of below 120 Hz.

For 3D sound, it is important to set speakers corresponding to five channels except the low frequency effect channel with no directional component at proper places. That is, the 3D sound is produced by the five speakers set at the proper places.

Meanwhile, current techniques for providing and reproducing video or audio data over a network have mainly employing a streaming method for reproducing data in real-time without download, which is not a method for reproducing the data after downloading it into a hard disk drive.

However, when the audio data are provided by the above streaming method, it is difficult to give a 3D sound effect through transmission of five-channel audio data and setting of locations of the speakers corresponding to the five channels. When the five-channel audio data are transmitted as is over the network, real-time transmission of audio data may be almost impossible since a large amount of data should be transmitted in a limited bandwidth. Accordingly, a method for down-mixing the five-channel audio data into two left and right audio-channel data and streaming the two left and right audio-channel data has been sometimes used.

However, when the five-channel audio data are down-mixed to the two right and left-channel audio data after being simply divided into left and right components, it is difficult to keep the 3D effect of sound. Accordingly, to keep the 3D effect of sound even when the five-channel audio data are down-mixed to two channels, a method has been employed in which the five-channel audio data are subject to a binaural synthesis.

A binaural effect, which is a basic principle of stereo playback, refers to an effect in which sound localization, i.e., direction and distance of sound sources, can be perceived when a user hears a certain sound with both ears while only sound strength is perceived when the user hears the certain sound with one ear. Accordingly, the binaural synthesis refers to a process for transforming a mono channel with no directionality into a signal with some directionality by passing the mono channel through a HRFT (Head Related Transfer Function) filter with specific-angled directionality.

That is, it has been possible to provide a streaming service of reducing an amount of data and maintaining the 3D effect of sound by giving directionality components to each of the five-channel audio data, down-mixing the five-channel audio data to two channels, and streaming the five-channel audio data.

However, it has been formally recommended that five resources of sound are placed at the center of the listener (that is, 0 degrees with respect to the listener) in the case of the center channel, at right and left 30 degrees with respect to the listener in the case of the right and left channels, and at right and left 120 degrees with respect to the listener in the case of the right and left surround channels, in order to hear the 3D sound. Most two-channel down-mixing methods complied with the above recommendation as it is. That is, even though it was possible to set various virtual locations of sound sources by using the HRTF, five virtual locations of sound resources were fixed at the center of the listener, at right and left 30 degrees with respect to the listener, and at right and left 120 degrees with respect to the listener, irrespective of the user's respective preference.

Meanwhile, when the audio data that are down-loaded to two channels are heard through a headphone, an offset effect (hereinafter, also referred to as “cross-talk”) due to inter-channel signal interference does not occur since a left channel enters a left ear and a right channel enters a right ear. However, when the two-channel audio data are heard through a speaker, the cross-talk occurs since a portion of the left channel enters the right ear and a portion of the right channel enters the left ear. Thus, there arises a need for a separate process of removing the cross-talk.

However, in general, in the audio data streaming service over a network, there is no consideration on the cross-talk or the cross-talk removal process is added irrespective of whether sound the output means is a speaker or headphones.

In addition, the cross-talk removal process is uniformly performed using a pre-assumed function (generally, locations of right and left 30 degrees with respect to a user), irrespective of actual placement locations of the speaker from the user.

### SUMMARY OF THE INVENTION

It is therefore an object of the present invention to provide audio data giving a 3D sound effect in a direction desired by a user in an audio data streaming service.

It is another object of the present invention to determine whether or not cross-talk is processed according to conditions of provided audio data output means.

It is yet another object of the present invention to perform a cross-talk process based on locations of speakers set by a user.

To achieve the above objects, according to one aspect, the present invention provides a system connected to a user terminal over a network for providing audio data to the user terminal, comprising: a condition setting unit in which audio data provision conditions including conditions regarding virtual locations of sound sources designated by the user are set; and an audio data processor for giving an input audio signal a 3D sound effect in a direction desired by the user using a transfer function preset based on the conditions regarding locations of virtual sound sources designated by the user and outputting the input audio signal with the 3D sound effect.

Here, the conditions set in the condition setting unit can be changed by the user in real-time.

The system can further comprise a cross-talk processor for removing an offset effect due to interaction between output audio signals, and the cross-talk processor can be configurable to operate based on condition regarding output means set in the condition setting means.

Particularly, the condition regarding output means can include the kind of output means such as headphones or a speaker, and the cross-talk processor can be configurable to perform an audio signal offset effect removal function if the kind of output means is the speaker. In this case, the condition regarding output means includes locations of the speaker from the user, and the cross-talk processor can be configurable to perform an audio signal offset effect removal function based on the locations of the speaker set by the user.

According to another aspect, the present invention provides a method for providing audio data in a system connected to a user terminal over a network for providing the audio data to the user terminal, the method comprising the steps of: a) setting audio data provision conditions including conditions regarding virtual locations of sound sources designated by the user; b) giving an input audio signal a 3D sound effect in a direction desired by the user using a transfer function preset based on the set audio data provision conditions regarding locations of virtual sound sources designated by the user; and c) outputting the input audio signal with the 3D sound effect.

Here, the audio data provision conditions set in the step a) are changed by the user in real-time. In addition, the method further comprises the steps of d) selecting the kind of output means; and e) removing an offset effect due to interaction between output audio signals if the kind of output means is a speaker.

The method further includes setting locations of the speaker from the user if the kind of output means is a speaker, and wherein an audio signal offset effect is removed based on the set locations of the speaker.

According to yet another aspect, the present invention provides a system connected to a user terminal over a network for providing audio data to the user terminal, comprising: a condition setting unit in which conditions regarding output means including the kind of output means of the audio data designated by the user are set; and a cross-talk processor for removing an offset effect due to interaction between output audio signals, wherein the cross-talk processor operates based on the conditions regarding output means set in the condition setting means.

According to yet another aspect, the present invention provides a method for providing audio data in a system connected to the user terminal over a network for providing the audio data to the user terminal, the method comprising the steps of: a) setting conditions regarding output means including the kind of output means of the audio data designated by the user; and b) removing an audio signal offset effect due to interaction between audio signals if the kind of output means is a speaker.

### BRIEF DESCRIPTION OF THE DRAWINGS

FIG. 1 is a diagram illustrating an entire configuration of an audio data provision system according to an embodiment of the present invention;

FIG. 2 is a diagram illustrating a detailed configuration of a service provision server shown in FIG. 1;

FIG. 3 is a diagram illustrating a relationship between an input signal and a signal that is heard by a user's ears;

FIG. 4 is a flowchart illustrating an audio data provision method according to an embodiment of the present invention;

FIG. 5 is a diagram illustrating a two-channel down-mix process when the number of channels for an input audio signal is more than 3;

FIG. 6 is a diagram illustrating a two-channel down-mix process when the number of channels for an input audio signal is less than 2; and

FIG. 7 is a diagram illustrating a process of final output of audio data that has passed through the process of FIG. 5 or 6.

### DETAILED DESCRIPTION OF THE PREFERRED EMBODIMENT

Hereinafter, embodiments of the present invention will be described in detail with reference to the accompanying drawings.

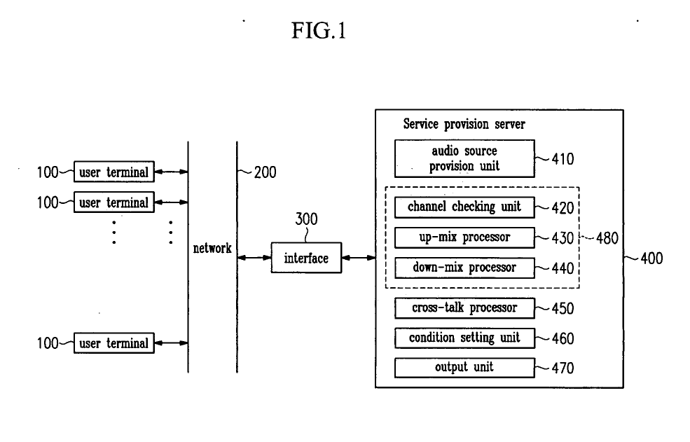

As shown in FIG. 1, an audio data provision system according to an embodiment of the present invention is connected to a plurality of user terminals 100 over a network 200 (including various forms of networks such as a telephone network, the Internet, a wireless communication network, and the like) and includes an interface 300 and a service provision server 400.

Each user terminal 100 refers to a communication device that can be connected to a system over a network and generally includes various communication devices such as a wired telephone, a wireless communication terminal, a computer, an Internet-accessible television, and the like. In the present invention, particularly, each user terminal 100 refers to a communication device that can receive and output audio data.

The interface 300 includes a database inter-working unit (CGI (common gateway interface)) or the like for exchanging information with web servers or other systems, and the plurality of user terminals 100 can access the interface 300 over the network 200 such as a wired Internet, a wireless Internet, or the like. In addition, the interface 300 converts various information received from the service provision server 400 performing the audio data provision service in compliance with a communication standard, provides the converted information to the plurality of user terminals 100, receives information from the user terminals 100 over the network 200, and transmits the received information to the service provision server 400.

The service provision server 400 provides the user terminals 100 with the audio data provision service and includes an audio source provision unit 410 providing a source of sound source, an audio data processor 480, a cross-talk processor 450, a condition setting unit 460, and an output unit 470. The audio data processor 480 includes a channel checking unit 420, an up-mix processor 430, and a down-mix processor 440.

The output unit 470 outputs final results of the audio data processed by the audio data provision system and then transmits them to the user terminals 100.

The cross-talk processor 450 removes the cross-talk caused when a part of a left channel enters a right ear and a part of a right channel enter a left ear in listening to two-channel audio data through a speaker rather than through headphones.

Conditions regarding audio data provision designated by the user are set in the condition setting unit 460. Conditions regarding audio data include virtual locations of sound sources, the kinds of output means, and locations of speakers from the user. Also, the condition setting can be configured to allow the user to change the conditions in real-time, which provides an advantage of immediate coping with conditions desired by the user.

Here, the designation of virtual locations for sound sources means that the user designates directions in which the user desires to listen to five-channel audio data. For example, it can follow a standard recommendation by designating the center, right and left, surround right and left channels at locations of 0 degrees, left and right 30 degrees, and left and right 120 degrees with respect to the user. Of course, other various settings are also possible.

The designation of the kinds of output means refers to selecting, for example, whether the user listens to audio data received via the network 200 by means of a speaker or headphones (hereinafter, including all sound output devices through which the audio data are transmitted directly to a user's ears, irrespective of what they are actual called). Of course, it can be configured to various other kinds of output means. Whether or not the cross-talk processor 450 performs depends on the kinds of output means set.

The locations of speakers from the user refers to angles of the speakers with respect to the user. A cross-talk removal function of the cross-talk processor 450 is changed according to these locations.

The audio data processor 480 gives a 3D sound effect to the sound sources received from the audio source provision unit 410 and performs a two-channel down-mix process for the sound sources.

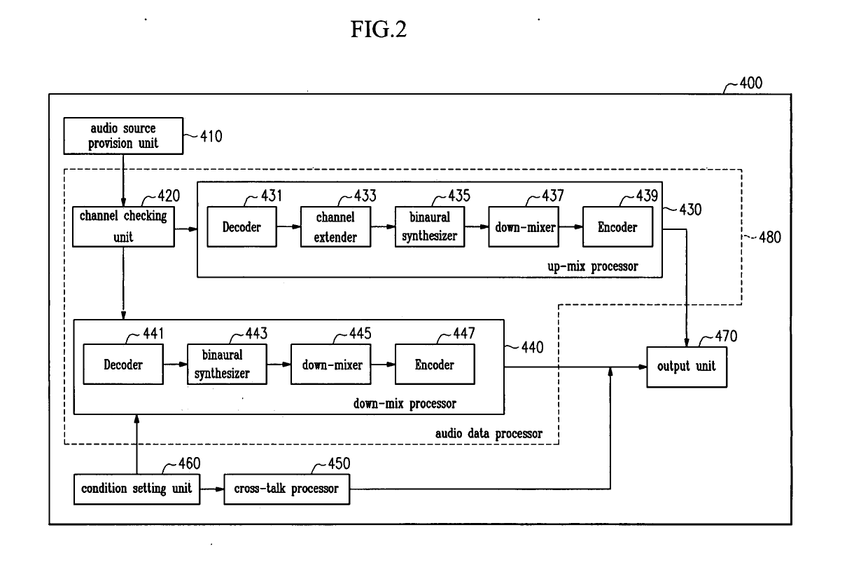

As shown in FIG. 2, the audio data processor includes the channel checking unit 420, the up-mix processor 430 for giving a 3D effect to sound and performing a two-channel down-mix process for the sound after extending the number of channels when the number of channels of sound sources is less than 2, and the down-mix processor 440 for giving a 3D effect to sound and performing a two-channel down-mix process for the sound when the number of channels of sound sources is more than 3.

The channel checking unit 420 checks the number of channels of sound sources received from the audio source, and transmits the sound sources to the up-mix processor 430 or the down-mix processor 440 depending on the number of channels.

The up-mix processor 430 processes the audio data when the number of channels of sound sources is less than 2, and includes a decoder 431, a channel extender 433, a binaural synthesizer 435, a down-mixer 437, and an encoder 439.

The decoder 431 separates a received sound source into right and left channels.

The channel extender 433 extends two-channel audio data to four-channel audio data. The channel extender 433 by-passes the right and left channels received from the decoder 431, and at the same time, multiplies right and left channel signals by corresponding appropriate gains, and then produces surround right and left signals by summing resultant values of the multiplication, as shown below.
Left Surround=(gain1*left)+(gain2*right)
Right Surround=(gain2*left)+(gain1* right)

That is, the channel extender 433 extends the two-channel audio data of the right and left channels to four-channel audio data of right and left and surround right and left channels.

Next, the binaural synthesizer 435 gives directionality to each channel through the binaural synthesis based on the head-related transfer function and separates the four-channel audio data into eight signal components. In this case, the head-related transfer function corresponding to conditions regarding virtual locations of sound sources, which are set in the condition setting unit 460, is used. Typically, head-related transfer functions corresponding to 60 degrees and 120 degrees are used for left/right signals and surround left/right signals, respectively.

The down-mixer 437 mixes eight signal components into two channels by summing left/right signal components in a proper size among the same components. The encoder encodes the two-channel audio data.

The down-mix processor 440 processes the audio data when the number of channels of sound sources is more than 3, and includes a decoder 441, a binaural synthesizer 443, a down-mixer 445, and an encoder 447. Hereinafter, a description will be given to a case where the number of channels of sound sources is 5.1.

The decoder 441 separates a received sound source into six channels, that is, center, right and left, surround right and left, and low frequency effect channels.

Next, the binaural synthesizer 443 gives directionality to channels except the low frequency effect channel through the binaural synthesis based on the head-related transfer function and separates audio data of five channels except the low frequency effect channel into ten signal components. The low frequency effect channel is simply divided into right and left signal components without consideration on the directionality.

In this case, the head-related transfer function corresponding to conditions regarding locations of virtual sound sources, which are set in the condition setting unit 460, is used. Typically, head-related transfer functions corresponding to 0 degrees, 30 degrees, and 120 degrees are used for center, left/right, and surround left/right signals, respectively.

The down-mixer 445 mixes the ten signal components and the left/right signal components of the low frequency effect channel into two channels by summing left/right signal components in a proper size among the same components. Then, the encoder 447 encodes the two-channel audio data.

The audio data that are separated into two channels through the audio data processor are outputted to the right and left channels as is if the output means is headphones, and undergo a signal offset effect removal process by the cross-talk processor 450 if the output means is a speaker.

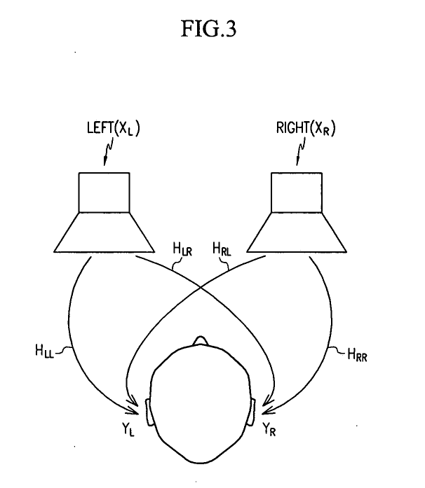

As shown in FIG. 3, assuming right and left sound signals that are finally heard by a user's ears and input right and left signals are variables Y_{L}, Y_{R}, and variables X_{L}, X_{R}, respectively, a relationship between the variables and the head-related transfer function (HRFT, H in the following equation) is represented as follows:
Y=HX, that is,

$$[ \begin{matrix}{Y}_{L} \\ {Y}_{R}\end{matrix} ] = [ \begin{matrix}{H}_{LL} & {H}_{RL} \\ {H}_{LR} & {H}_{RR}\end{matrix} ] [ \begin{matrix}{X}_{L} \\ {X}_{R}\end{matrix} ]$$

Here, cross-talk removal means that a signal that is heard to a user's ears through a speaker becomes substantially equal to a sound signal that is heard by the user's ears through a headphone. Since sound outputted through the headphones is directly delivered to the user's ears, the output sound signal of the headphones is substantially equal to the sound signal that is delivered to the user's ears through the headphones.

That is, it can be said that the cross-talk removal is a process of making the output sound signal of the speaker equal to the sound signal that is delivered to the user's ears through the headphones.

Accordingly, assuming the sound signal outputted from the headphones is B(B_{L}, B_{R}), an input signal X to make the sound signal Y delivered to the user's ears equal to B may be obtained. That is, when a signal X that is inputted to the speaker is H⁻¹B, Y=HX=H(H⁻¹ B)=B. Thus, the same signal as the output sound signal of the headphones is delivered to the user's ears, that is, the signal offset effect is removed.

In sum, if the user's sound output means is the headphones, the two-channel audio data processed in the audio data processor are outputted to the right and left channels as is, respectively. If the user's sound output means is the speaker, the two-channel audio data processed in the audio data processor are separated into the left and right channels, and each of signals of the left and right channels is convoluted with H⁻¹, thereby removing the cross-talk.

In this case, the head-related transfer function to be used is determined according to the locations of speakers set in the condition setting unit 460. Typically, the head-related transfer function corresponding to a location of 30 degrees from the user is used.

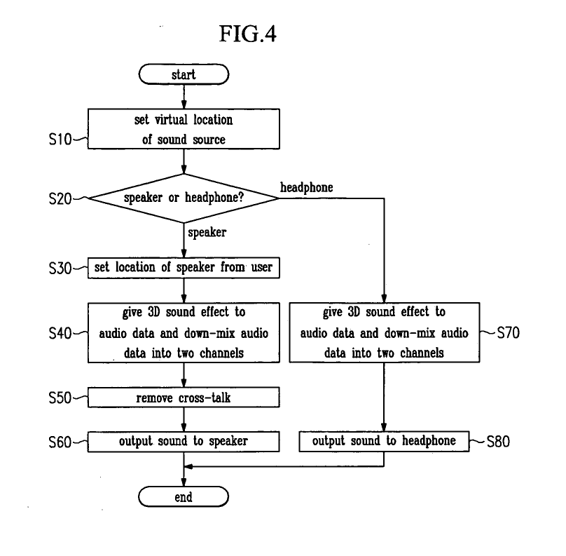

Hereinafter, an audio data provision method of the audio data provision system according to an embodiment of the present invention will be described in detail with reference to FIG. 4.

When the user designates specific conditions regarding a virtual location of a sound source, the user-designated conditions regarding the virtual location of the sound source are set in the condition setting unit 460 (S10). In addition, the user designates a condition regarding whether the audio data output means is a speaker or headphones, and this condition is also set in the condition setting unit 460 (S20).

If the set output means is the headphones, a sound source received from the audio source provision unit is down-mixed into two channels in the audio data processor (S70) and then is transmitted to the user's ears through the headphones (S80).

On the other hand, if the output means is the speaker, the location of the speaker from the user is additionally set in the condition setting unit 460 (Step 30). In this case, the user can change the conditions regarding virtual locations of sound sources in real-time, the conditions regarding locations of speakers and the like.

Next, like the case where the output means is the headphones, a sound source received from the audio source provision unit is down-mixed into two channels in the audio data processor (S40). However, in the case of the speaker, a cross-talk removal process is additionally performed (S50).

In the end, the sound signal that passed through the cross-talk process is outputted through the speaker (S60).

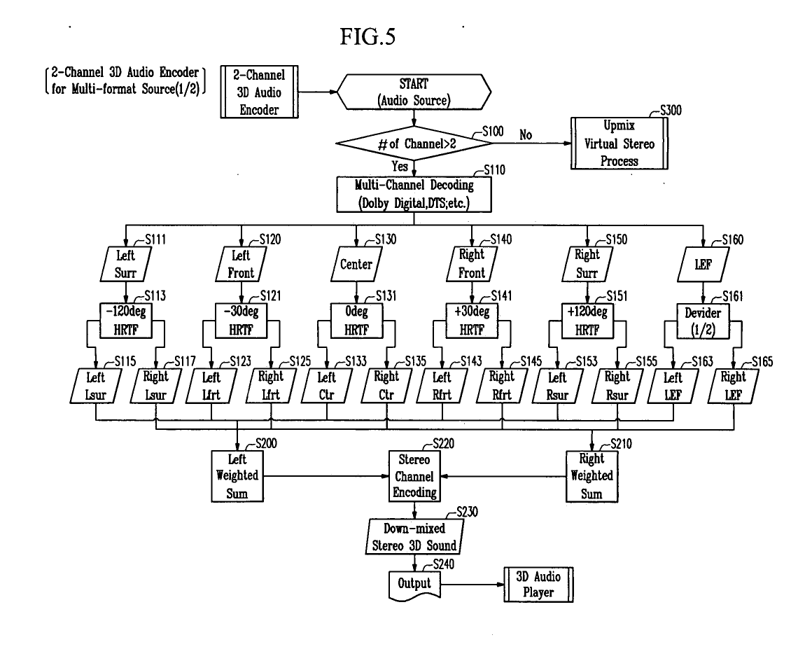

At this time, as shown in FIG. 5, the two-channel down-mixing of the audio data through the audio data processor has no relation with the kind of set output means.

That is, when the sound signal is inputted from the audio data provision unit, the number of channels of the input audio signal is checked in Step S100. In this case, if the number of channels of the input audio signal is more than 3, the input audio signal is decoded into multi-channels (S110). A case where the input audio signal whose number of channels is 5.1 and is decoded into six channels is shown as an example in this figure.

That is, when the input audio signal is decoded into center, left and right, surround left and right, and low frequency effect channels (S110), directionality is given to five channels except the low frequency effect channel without directionality by using the head-related transfer function, and then the five channels are divided into ten signal components. At this time, the head-related transfer function used is a head-related transfer function corresponding to conditions regarding locations of virtual sound sources, which are designated and set by the user. Typically, the head-related transfer function corresponding to 0 degrees, 30 degrees, and 120 degrees are used for center, left/right, and surround left/right signals, respectively (S111 to S117, S120 to S125, S130 to S135, S140 to S145, S150 to S155, and S160 to S165).

The low frequency effect channel is simply divided into the right and left signal components with no consideration on the directionality (S160 to S165).

Two channels are created by summing the ten signal components and the left/right signal components of the low frequency effect channel in a proper size among the same components (S200, S210). Then, the two-channel audio data are encoded (S220, S230).

On the other hand, the number of channels of the input audio signal is checked in Step S100. If the number of channels is less than 2 (S300), the following process is performed. Hereinafter, a case where the number of channels of the input audio signal is two will be described.

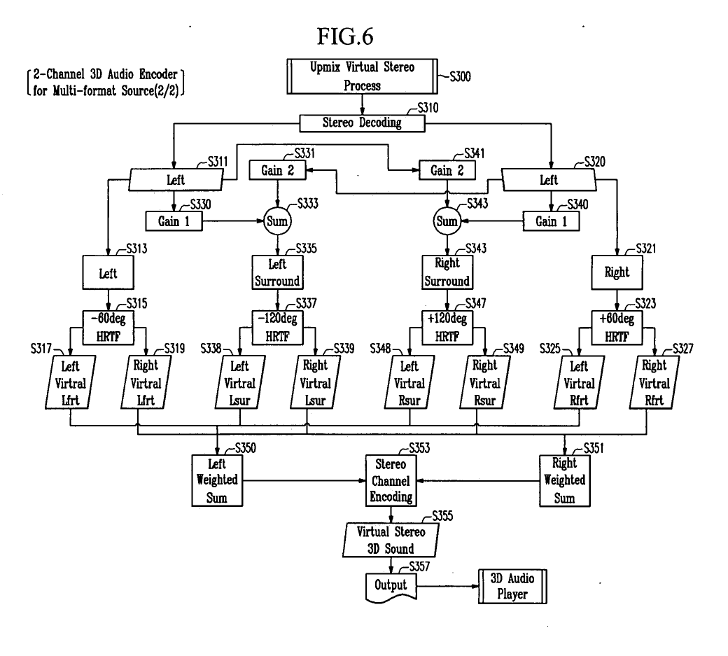

As shown in FIG. 6, the input audio signal is decoded into two left and right channels (S310), and the two-channel audio data are extended to four-channel audio data. That is, the two decoded left and right channels are by-passed, and at the same time, the left and right channel signals are multiplied by proper gains, respectively, and then the surround left and right signals are created by summing results of the multiplication (S 311 to S313, S320 to S321, S330 to S335, and S340 to S345).

Next, directionality based on the head-related transfer function is given to each of the four-channel audio data, and the four-channel audio data are separated into eight signal components (S315 to S319, S323 to S327, S337 to S339, and S347 to S349). In this case, the head-related transfer function corresponds to the conditions regarding virtual locations of sound sources, which are designated by the user. Typically, the head-related transfer functions corresponding to 60 degrees and 120 degrees are used for the left/right signals and the surround left/right, respectively.

Next, two channels are created by summing the eight signal components among the same components in Steps S350 and S351, and are then encoded (S353 and S357).

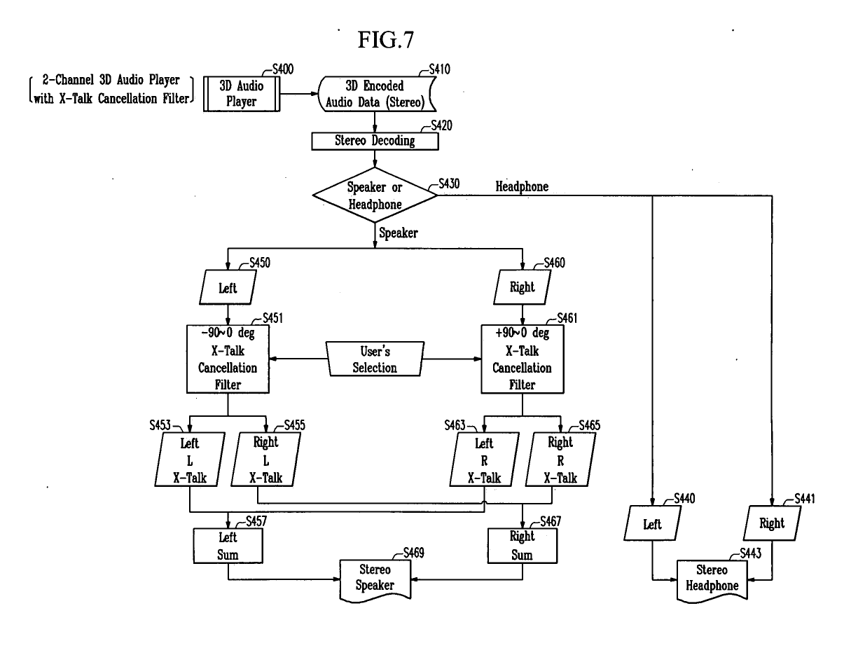

As shown in FIG. 7, the two channel-audio data that were created and encoded through the above process are decoded into the two left/right channels (S400 to S420).

In this case, when the user's sound output means is the headphones (S430), the two left/right channel audio data are outputted through the output unit 470 as is (S440 to S443). On the other hand, when the user's sound output means is the speaker (S430), the two left/right channel audio data undergo the cross-talk removal process (S450 to S467).

That is, the cross-talk is removed by convoluting each channel signal with an inverse function of the head-related transfer function. In this case, the head-related transfer function used is determined according to the location of speaker set by the user's designation. Typically, the head-related transfer function corresponding to the location of 30 degrees from the user is used.

Then, the sound signal that has undergone the cross-talk removal process is transmitted to the user's speaker through the output unit 470 (S469).

While the embodiment of the present invention have been described in detail, it should be understood that the present invention is not restricted in the embodiments and may be modified or changed in various forms without deviating from the spirit and scope of the invention

As described above, according to the present invention, since the 3D sound effect is given to the input audio signal by using a specific transfer function, based on the conditions regarding virtual locations of sound source designated by the user, the user can enjoy the sound with the 3D effect in directions desired by the user.

Also, since whether or not the cross-talk removal function is performed can be determined according to the kind of output means, the cross-talk removal function can be performed as necessary such as when the user hears music through a speaker, while unnecessary performance of the cross-talk function such as when the user hears the music through headphones is avoided.

In addition, when the output means is the speaker, since the cross-talk removal function is performed based on a pair of mutual locations of speakers set and used by the user, the cross-talk removal can be more efficiently achieved.

1. A system connected to a user terminal over a network for providing audio data to the user terminal, comprising:
a condition setting unit in which audio data provision conditions including conditions regarding virtual locations of sound sources designated by the user are set; and
an audio data processor for giving an input audio signal a 3D sound effect in a direction desired by the user using a transfer function preset based on the conditions regarding virtual locations of sound sources designated by the user and outputting the input audio signal with the 3D sound effect.

2. The system of claim 1, wherein the conditions set in the condition setting unit are changed by the user in real-time.

3. The system of claim 1 or 2, further comprising:
a cross-talk processor for removing an offset effect due to interaction between output audio signals,
wherein the cross-talk processor operates based on a condition regarding output means set in the condition setting means.

4. The system of claim 3, wherein the condition regarding output means includes the kind of output means such as headphones or a speaker, and
wherein the cross-talk processor performs an audio signal offset effect removal function if the kind of output means is the speaker.

5. The system of claim 4, wherein the condition regarding output means includes locations of the speaker from the user, and
wherein the cross-talk processor performs an audio signal offset effect removal function based on locations of the speaker set by the user.

6. The system of claim 1 or 2, wherein the audio data processor includes:
a channel checking unit for checking the number of channels of the input audio signal;
an up-mix processor for extending the number of channels if the number of channels checked by the channel checking unit is less than 2, giving a 3D sound effect to the input audio signal, and then outputting the input audio signal to stereo channels; and
a down-mix processor for giving a 3D sound effect to the input audio signal if the number of channels checked by the channel checking unit is more than 3, and then outputting the input audio signal to the stereo channels.

7. The system of claim 6, wherein the down-mix processor includes:
a decoder for decoding the input audio signal;
a binaural synthesizer for giving the 3D sound effect to the decoded audio signal using the preset transfer function;
a down-mixer for down-mixing the audio signal with the 3D sound effect into two channels; and
an encoder for encoding the audio signal down-mixed into the two channels.

8. The system of claim 6, wherein the up-mix processor includes:
a decoder for decoding the input audio signal;
a channel extender for extending the number of channels of the decoded audio signal;
a binaural synthesizer for giving the 3D sound effect to each channel of the audio signal using the preset transfer function;
a down-mixer for down-mixing the audio signal with the 3D sound effect into two channels; and
an encoder for encoding the audio signal down-mixed into the two channels.

9. A method for providing audio data in a system connected to a user terminal over a network for providing the audio data to the user terminal, the method comprising the steps of:
a) setting audio data provision conditions including conditions regarding virtual locations of sound sources designated by the user;
b) giving an input audio signal a 3D sound effect in a direction desired by the user using a transfer function preset based on the set audio data provision conditions regarding virtual locations of sound sources designated by the user; and
c) outputting the input audio signal with the 3D sound effect.

10. The method of claim 9, wherein the audio data provision conditions set in the step a) are changed by the user in real-time.

11. The method of claim 9 or 10, further comprising the steps of:
d) selecting the kind of output means; and
e) removing an offset effect due to interaction between output audio signals if the kind of output means is a speaker.

12. The method of claim 11, wherein the step e) further includes setting locations of the speaker from the user if the kind of output means is a speaker, and wherein an audio signal offset effect is removed based on the set locations of the speaker.

13. The method of claim 9 or 10, wherein the step b) further includes:
b-1) checking the number of channels of the input audio signal; and
b-2) extending the number of channels if the number of channels is less than 2, giving each of the extended channels a 3D sound effect in directions desired by the user using the preset transfer function, down-mixing the extended channels into two channels, and then outputting the down-mixed channels

14. The method of claim 13, further comprising the step of, after the step b-1):
b-3) giving each of the extended channels a 3D sound effect in directions desired by the user using the preset transfer function if the number of channels is more than 3, down-mixing the extended channels into two channels, and then outputting the down-mixed channels.

15. The method of claim 13, wherein the step b-2) further includes:
b-2-1) decoding the audio signal if the number of channels of the audio signal is less than 2;
b-2-2) extending the number of channels of the decoded audio signal;
b-2-3) giving the 3D sound effect to each channel of the audio signal using the preset transfer function;
b-2-4) down-mixing the audio signal with the 3D sound effect into two channels; and
b-2-5) encoding the audio signal down-mixed into the two channels into stereo channels.

16. The method of claim 14, wherein the step b-3) further includes:
b-3-1) decoding an input audio signal if the number of channels of the audio signal is more than 3;
b-3-2) giving the 3D sound effect to the decoded audio signal using the preset transfer function;
b-3-3) down-mixing the audio signal with the 3D sound effect into two channels; and
b-3-4) encoding the audio signal down-mixed into the two channels.

17. A system connected to a user terminal over a network for providing audio data to the user terminal, comprising:
a condition setting unit in which conditions regarding output means including the kind of output means of the audio data designated by the user are set; and
a cross-talk processor for removing an offset effect due to interaction between output audio signals,
wherein the cross-talk processor operates based on the conditions regarding output means set in the condition setting means.

18. The system of claim 17, wherein the cross-talk processor removes an audio signal offset effect if the kind of output means is a speaker.

19. The system of claim 18, wherein locations of the speaker from the user are set in the condition setting unit if the kind of output means is the speaker, and
wherein the cross-talk processor performs an audio signal offset effect removal function based on the set locations of the speaker.

20. The system of any one of claims 17 to 19, wherein the conditions set in the condition setting unit are changed by the user in real-time.

21. A method for providing audio data in a system connected to the user terminal over a network for providing the audio data to the user terminal, the method comprising the steps of:
a) setting conditions regarding output means including the kind of output means of the audio data designated by the user; and
b) removing an audio signal offset effect due to interaction between audio signals if the kind of output means is a speaker.

22. The method of claim 21, wherein the step b) further includes setting locations of the speaker from the user if the kind of output means is the speaker, and wherein the audio signal offset effect is removed based on the set locations of the speaker.
